(19) United States
(12) Patent Application Publication
(10) Pub. No.: US 2025/0383154 A1
(43) Pub. Date: Dec. 18, 2025

(54) HEAT TREATMENT SYSTEM

(71) Applicant: NGK INSULATORS, LTD., Nagoya-Shi (JP)

(72) Inventors: Michiro AOKI, Obu-Shi (JP); Tsutomu ITO, Nagoya-Shi (JP); Takeshi KOMAKI, Nagoya-Shi (JP)

(73) Assignee: NGK INSULATORS, LTD., Nagoya-Shi (JP)

(21) Appl. No.: 19/190,912

(22) Filed: Apr. 28, 2025

(30) Foreign Application Priority Data
Jun. 17, 2024 (JP) 2024-097351

(51) Int. Cl. F27B 9/28; F27B 9/02; F27D 3/00

(52) U.S. Cl. CPC F27B 9/28; F27B 9/028; F27D 3/00; F27D 2003/0043

(57) ABSTRACT

A heat treatment system may include: an unwinding mechanism configured to unwind a ribbon-shaped treatment object; a plurality of rollers configured to convey the treatment object by each roller rotating after the treatment object has been unwound by the unwinding mechanism; and a firing furnace configured to fire the treatment object conveyed by the plurality of rollers. The plurality of rollers may be constituted of a heat-resistant material that is usable in a temperature range of 600° C. to 1400° C. and conveys the treatment object while being in contact with the treatment object.

### REFERENCE TO RELATED APPLICATIONS

This application claims priority to Japanese Patent Application No. 2024-097351 filed on Jun. 17, 2024. The entire content of the priority application is incorporated herein by reference.

### TECHNICAL FIELD

The disclosure herein relates to a heat treatment system.

### BACKGROUND ART

Japanese Patent Application Publication No. 2001-31476 describes a firing apparatus including a tunnel-shaped firing furnace and an endless belt that extends horizontally through the firing furnace, is moved at a constant speed in a moving direction, and is constituted of inorganic fibers. In this firing apparatus, a long unfired sheet is pulled out from an unfired sheet roll and is then sent onto the endless belt and conveyed through the firing furnace on the endless belt. After heated, the resulting ceramic sheet is wound up onto a ceramic sheet roll.

According to Japanese Patent Application Publication No. 2001-31476, the endless belt of inorganic fibers moves in a loop inside and outside the firing furnace. However, such belts constituted of inorganic fibers are likely to break when they are bent repeatedly, and thus are less practical as a conveying means for a treatment object.

### SUMMARY

The disclosure herein provides a technology suitable for conveying a treatment object while suppressing breakage thereof.

In an aspect of the art disclosed herein, a heat treatment system is disclosed. The heat treatment system may comprise an unwinding mechanism configured to unwind a ribbon-shaped treatment object; a plurality of rollers configured to convey the treatment object by each roller rotating after the treatment object has been unwound by the unwinding mechanism; and a firing furnace configured to fire the treatment object conveyed by the plurality of rollers. The plurality of rollers may be constituted of a heat-resistant material that is usable in a temperature range of 600° C. to 1400° C. and conveys the treatment object while being in contact with the treatment object.

According to the configuration above, after unwound by the unwinding mechanism, the treatment object is placed directly on the plurality of rollers, which is usable in a high temperature range of 600° C. to 1400° C. and is constituted of a heat-resistant material, and is fired in the firing furnace while being conveyed by the rotation of each roller.

### BRIEF DESCRIPTION OF DRAWINGS

FIG. 1 is a schematic diagram of a heat treatment system.

FIG. 2 is a diagram for explaining roller speed control.

FIG. 3 is a schematic diagram of an exemplary heat treatment system different from the one shown in FIG. 1.

### DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved heat treatment systems as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Some of the features characteristic to below-described embodiments will herein be listed. It should be noted that the respective technical elements are independent of one another, and are useful solely or in combinations. The combinations thereof are not limited to those described in the claims as originally filed.

In an aspect of the art disclosed herein, portions of surfaces of the plurality of rollers that contact the treatment object may be smoothed. This configuration suppresses the rollers from damaging the treatment object during the conveyance since a portion of the surface of each roller that contacts the treatment object is smoothed. Further, a certain level of slippage is provided between the treatment object and the portions of surfaces of the rollers that contact the treatment object, and thus tensile stress generated in a longitudinal direction of the treatment object during firing can be reduced.

In an aspect of the art disclosed herein, a surface roughness of the portions of the surfaces may be Ra 6.3 μm or less. The portions of surfaces of the rollers that contact the treatment object are polished so as to have the surface roughness of Ra 6.3 μm or less. Thus, damage to the treatment object by the rollers can be certainly suppressed.

In an aspect of the art disclosed herein, the plurality of rollers may be constituted of ceramics with an alumina content percentage of 50% to 70%. This allows the heat treatment system to convey the treatment object using the rollers with an excellent thermal shock resistant composition.

In an aspect of the art disclosed herein, the heat treatment system may further comprise a roller drive control unit configured to change a conveyance speed of one or more rollers of the plurality of rollers based on shrinkage of the treatment object caused by firing in the firing furnace. According to this configuration, the roller drive control unit changes the conveyance speed of one or more rollers according to the shrinkage of the treatment object. This suppresses generation of tensile stress in the treatment object more appropriately.

In an aspect of the art disclosed herein, the firing furnace may comprise a heating zone in which a temperature inside the firing furnace is increased; a maintaining zone in which the temperature inside the firing furnace increased in the heating zone is maintained; and a cooling zone in which the temperature inside the firing furnace is decreased. The heating zone, the maintaining zone, and the cooling zone may be arranged in this order from an upstream end to a downstream end of conveyance by the plurality of rollers. The roller drive control unit may slow down the conveyance speed of rollers located downstream of a predetermined position in the heating zone compared to rollers located upstream of the predetermined position. This configuration allows the roller drive control unit to slow down the conveyance speed of rollers located downstream of the predetermined position in the heating zone based on the thermal shrinkage of the treatment object which is caused while the treatment object is being conveyed in the heating zone of the firing furnace. Thus, generation of tensile stress in the treatment object can be certainly suppressed.

In an aspect of the art disclosed herein, the heat treatment system may further comprise a winding mechanism configured to wind up the treatment object fired by the firing furnace. This allows the heat treatment system to easily recover the treatment object fired in the firing furnace using the winding mechanism.

In an aspect of the art disclosed herein, the treatment object may be a glass, ceramics, a metal, or a mixture thereof. This allows the heat treatment system to convey the treatment object which is a glass, ceramics, a metal, or a mixture thereof and obtain the resulting fired object.

Referring to the drawings, an embodiment is described. The drawings merely show the embodiment by way of example, and the embodiment is not limited to what is shown in the drawings. Further, since the drawings merely shows an example, depiction may be partially omitted.

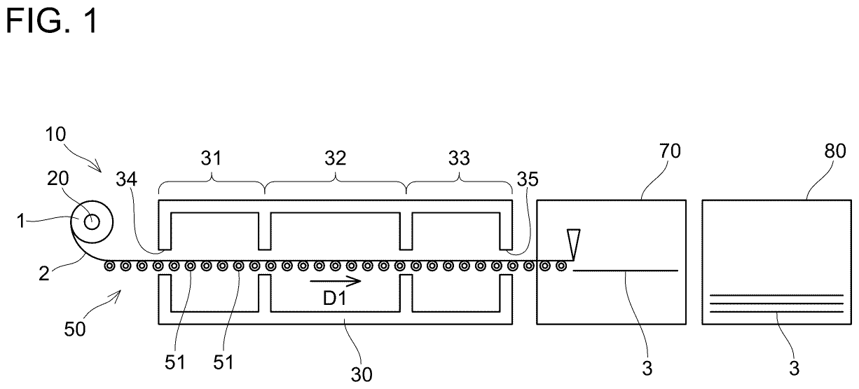

FIG. 1 schematically shows a heat treatment system 10. The heat treatment system 10 comprises an unwinding mechanism 20 and a firing furnace 30. The unwinding mechanism 20 holds a roll body 1 on which a long treatment object 2 is wound around. The treatment object 2 has a ribbon shape. Further, the treatment object 2 is, for example, a glass, ceramics, a metal, or a mixture thereof. The ribbon shape includes woven fibers, unwoven fabric, film shape, foil shape, etc. The unwinding mechanism 20 rotates to unwind (unreel) the treatment object 2 from the roll body 1. The treatment object 2 is flexible before and after it is fired in the firing furnace 30.

The firing furnace 30 fires or heat treats the treatment object 2 in the furnace by the heat generated by heaters (not shown). The firing furnace 30 is a substantially cuboid heat-insulating structure and elongated in a predetermined conveying direction D1. The firing furnace 30 comprises an entrance 34 at its upstream end in the conveying direction D1 and an exit 35 at its downstream end in the conveying direction D1. Hereinbelow, when “upstream” and “downstream” are mentioned, they respectively refer to upstream and downstream sides with respect to the conveying direction D1.

A roller group 50 includes a plurality of rollers 51 arranged at predetermined intervals along the conveying direction D1 and extends inside and outside the firing furnace 30 through the entrance 34 and the exit 35. The roller group 50 may be referred to as a conveyor mechanism. The rotation axes of the rollers 51 are parallel to each other and perpendicular to the conveying direction D1. After unwound by the unwinding mechanism 20, the treatment object 2 is placed on the rollers 51 at a position upstream of the entrance 34. That is, in this embodiment, the treatment object 2 is placed directly on the rollers 51. The rollers 51 each rotate to convey the treatment object 2 in the conveying direction D1 while being in contact with the treatment object 2.

The treatment object 2 on the roller group 50 enters the firing furnace 30 through the entrance 34 and is fired while being conveyed through the firing furnace 30. After conveyed out from the firing furnace 30 through the exit 35 by the roller group 50, the treatment object 2, which has been fired by the firing furnace 30, separates from the rollers 51 at a position downstream of the exit 35.

In the example shown in FIG. 1, the heat treatment system 10 comprises a cutting device 70 and a storage device 80 located downstream of the exit 35. After conveyed out from the firing furnace 30 through the exit 35, the treatment object 2 is conveyed on the roller group 50 to the cutting device 70 and is then cut into pieces of a predetermined size by a cutter of the cutting device 70. A cut treatment object 3, i.e., the piece of the treatment object 2 are recovered and stored in the storage device 80.

As seen from FIG. 1, the unwinding mechanism 20 is positioned higher than the position where the roller group 50 supports the treatment object 2. That is, in this embodiment, the treatment object 2 hangs down from the unwinding mechanism 20 and the roller group 50 supports and conveys the hanging treatment object 2. The roller group 50 may be considered as supporting the treatment object 2 horizontally or substantially horizontally.

The plurality of rollers 51 making up the roller group 50 is constituted of a material that can stably retain its shape even under changes in the temperature within the firing furnace 30 and under the maximum temperature therein. In this embodiment, the rollers 51 are each constituted of a heat-resistant material usable in a temperature range of 600° C. to 1400° C. Assuming that the maximum temperature in the furnace is in a range of 1000° C. to 1300° C., the rollers 51 may each be constituted of a heat-resistant material usable in a high temperature range of 1000° C. to 1300° C. Materials being usable in these specific temperature ranges means that the materials are also usable in any temperature ranges that do not exceed the specific temperature ranges.

As an exemplary composition suitable for the rollers 51, the rollers 51 are each constituted of ceramics with an alumina (Al₂O₃) content percentage of 50% to 70%. Mullite is a specific example of such ceramics containing alumina in that percentage range. Mullite is a compound of alumina and silica (SiO₂), has a lower thermal expansion rate than alumina, and has excellent thermal shock resistant.

In this embodiment, a portion of the surface of each roller 51 that contacts the treatment object 2 is smoothed. The other portion of the surface of each roller 51 that does not contact the treatment object 2 during the conveyance may not be smoothed. Portions of surfaces being smoothed means that the portions of surfaces have been polished. Here, an example is described assuming that the rollers 51 are constituted of mullite. While mullite has a larger particle diameter and provides a rougher surface than alumina, surface smoothness can be achieved by polishing. The surface roughness of the portions of surfaces of the rollers 51 that contact the treatment object 2 is, for example, Ra 6.3 μm or less. The surface roughness Ra is an arithmetic average roughness. The portion of surface of each roller 51 that contacts the treatment object 2, that is, the smoothed portion of surface may account for, for example, 80% or less of the longitudinal area of the roller 51, including the center of the roller 51. In this case, for example, the opposing end portions of each roller 51 in the longitudinal direction of the rollers 51 are not smoothed. The smoothed portion of surface of each roller 51 may be symmetric or asymmetric with respect to the center of the roller 51 in the longitudinal direction of the roller 51.

As described, according to this embodiment, the heat treatment system 10 comprises the unwinding mechanism 20 configured to unwind the ribbon-shaped treatment object 2, the plurality of rollers 51 configured to convey the treatment object 2 by each roller 51 rotating after the treatment object 2 has been unwound by the unwinding mechanism 20, and the firing furnace 30 configured to fire the treatment object 2 conveyed by the plurality of rollers 51. The plurality of rollers 51 is constituted of a heat-resistant material that is usable in the temperature range of 600° C. to 1400° C. and conveys the treatment object 2 while being in contact with the treatment object 2. That is, by using the plurality of rollers 51 as conveying means for the treatment object 2, the heat treatment system 10 solves a problem that belts constituted of inorganic fibers are likely to break by moving in a loop inside and outside of a firing furnace while being repeatedly bent, and thus are less practical. Conveying the treatment object 2 directly on the plurality of rollers 51 suppresses breakage of the treatment object 2 while it is conveyed.

Further, according to this embodiment, the portions of the surfaces of the rollers 51 that contact the treatment object 2 are smoothed. The surface roughness of the portions is, for example, Ra 6.3 μm or less. Thus, damage to the treatment object 2 is suppressed while it is conveyed on the rollers 51. Further, a certain level of slippage is provided between the treatment object 2 and the portions of surfaces of the rollers 51. This reduces tensile stress generated in the longitudinal direction of the treatment object 2 due to thermal shrinkage during firing, resulting in the fired treatment object 2 with less or no breakage and improved quality.

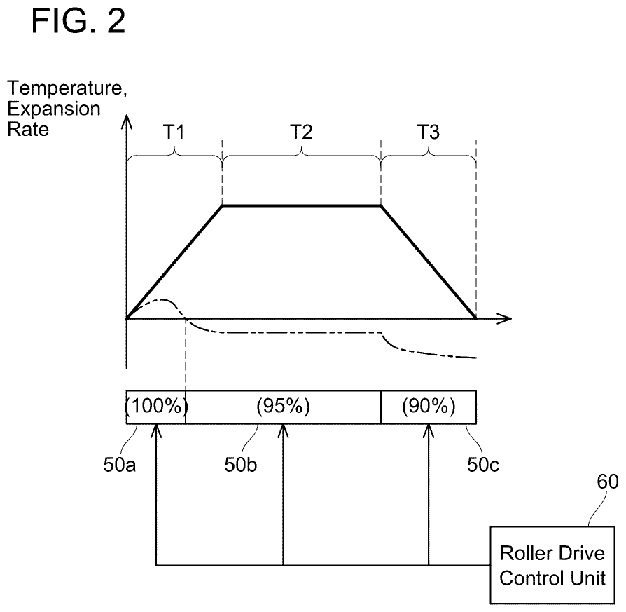

FIG. 2 shows a diagram for explaining roller speed control in this embodiment and shows a graph depicting a temperature profile of the firing furnace 30, etc. As shown in FIG. 1, the firing furnace 30 comprises three zones 31, 32, 33 that communicate with each other in the conveying direction D1 but are partially separated from each other. That is, the firing furnace 30 comprises a heating zone 31 in which the temperature inside the furnace is increased, a maintaining zone 32 in which the temperature inside the furnace increased in the heating zone 31 is maintained, and a cooling zone 33 in which the temperature inside the furnace is decreased. The heating zone 31, the maintaining zone 32, and the cooling zone 33 are arranged in this order from the upstream end of the firing furnace 30 toward the downstream end thereof. Thus, the entrance 34 can be regarded as the entrance to the heating zone 31, and the exit 35 can be regarded as the exit from the cooling zone 33.

In the graph shown in FIG. 2, an exemplary temperature profile is depicted with a solid line. The horizontal axis of the graph can be considered as representing positions along the conveying direction D1 from the entrance 34 to the exit 35 or as representing a lapse of time from the start of conveyance of the treatment object 2 in the conveying direction D1 from the entrance 34. The temperature profile includes a heating profile T1 associated with the heating zone 31, a maintaining profile T2 associated with the maintaining zone 32, and a cooling profile T3 associated with the cooling zone 33.

In the heating zone 31, outputs of the heaters are set such that the temperature inside the furnace is continuously increased from the room temperature up to a predetermined maximum temperature in the conveying direction D1, as shown by the heating profile T1. In the maintaining zone 32, outputs of the heaters are set such that the temperature inside the furnace is substantially maintained at the maximum temperature, as shown by the maintaining profile T2. In the cooling zone 33, outputs of the heaters and/or coolers are set such that the temperature inside the furnace is continuously decreased from the maximum temperature to the room temperature in the conveying direction D1, as shown by the cooling profile T3.

In this embodiment, the heat treatment system 10 further comprises a roller drive control unit 60. The roller drive control unit 60 is configured to change a conveyance speed of one or more rollers 51 of the plurality of rollers 51 based on shrinkage of the treatment object 2 caused by firing. The roller drive control unit 60 comprises, for example, one or more motors for rotating the rollers 51, a transmission mechanism for power transmission from the motor(s) to the rollers 51, a driver circuit for switching control of the motor(s) and the transmission mechanism, etc.

In the graph shown in FIG. 2, an exemplary expansion rate of the treatment object 2 conveyed through the firing furnace 30 is depicted with a two-dot-dash line. Referring to FIG. 2, the expansion rate of the treatment object 2 first gradually increases in the heating zone 31 but starts decreasing from a certain point. Then, the expansion rate of the treatment object 2 enters a negative range while the treatment object 2 is conveyed through the heating zone 31, that is, the treatment object 2 shrinks compared to its pre-heat treatment state. That is, FIG. 2 shows that the treatment object 2 thermally shrinks at a certain point while conveyed through the heating zone 31, this state is maintained until the treatment object 2 is conveyed out of the maintaining zone 32, and then the treatment object 2 thermally shrinks even further in the cooling zone 33.

This thermal shrinkage pattern of the treatment object 2 has been known from results of experiments and simulations conducted by the inventors. The roller drive control unit 60 changes the conveyance speed, i.e., rotation speed of one or more rollers 51 based on the thermal shrinkage pattern. In FIG. 2, among the plurality of rollers 51 making up the roller group 50, rollers 51 located inside the firing furnace 30 are divided into groups (sub-groups) based on their positions, and these sub-groups are labeled with reference signs 50a, 50b, and 50c. In FIG. 2, the sub-groups 50a, 50b, 50c are depicted as rectangles for clarification purposes, however, each of the sub-groups 50a, 50b, 50c actually comprises multiple rollers 51 aligned in the conveying direction D1.

A first sub-group 50a comprises some of the rollers 51 located in the heating zone 31, and these rollers 51 are generally located in a range from the entrance 34 to a predetermined position where the expansion rate of the treatment object 2 enters to the negative range as described above. A second sub-group 50b generally comprises remaining rollers 51 of the rollers 51 located in the heating zone 31 that do not belong to the first sub-group 50a, and rollers 51 located in the maintaining zone 32. A third sub-group 50c generally comprises rollers 51 located in the cooling zone 33.

The roller drive control unit 60 changes the conveyance speeds of the rollers 51 in the second sub-group 50b and the third sub-group 50c to slower speeds than the conveyance speed of the rollers 51 in the first sub-group 50a. This is an example of slowing down the conveyance speed of rollers 51 located downstream of the predetermined position in the heating zone 31 compared to rollers 51 located upstream of the predetermined position.

In FIG. 2, the numerical values in brackets for the respective first to third sub-groups 50a, 50b, 50c indicate speed differences. In an example, provided that the conveyance speed of the rollers 51 in the first sub-group 50a is 100%, the roller drive control unit 60 may set the conveyance speed of the rollers 51 in the second sub-group 50b to 95% and the conveyance speed of the rollers 51 in the third sub-group 50c to 90%. This roller speed control by the roller drive control unit 60 slows down the conveyance speed of the rollers 51 located downstream of the predetermined position and thus appropriately reduces tensile stress generated in the treatment object 2 even when the treatment object 2 thermally shrinks during firing in the firing furnace 30.

The roller speed control by the roller drive control unit 60 is not limited to the specific example described above. In the example shown in FIG. 2, the rollers 51 located in the firing furnace 30 are divided into three sub-groups with different conveyance speeds, however, the number of sub-groups may be two, or four or more. Further, the positions of the sub-groups within the firing furnace 30 may be varied depending on the temperature control in the firing furnace 30 and/or the characteristics of the treatment object 2 to be heat treated.

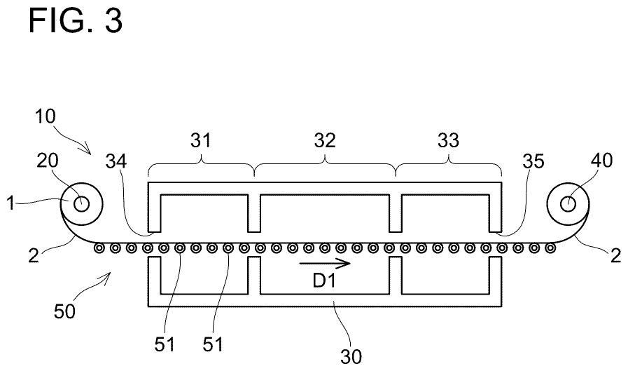

FIG. 3 shows a heat treatment system 10 according to an embodiment different from that shown in FIG. 1. For the embodiment shown in FIG. 3, differences from the embodiment shown in FIG. 1 are described. Referring to FIG. 3, the heat treatment system 10 does not comprise the cutting device 70 and the storage device 80 but comprises a winding mechanism 40 located downstream of the exit 35. After fired in the firing furnace 30, the treatment object 2 separates from the rollers 51 and is wound up by the winding mechanism 40. That is, the winding mechanism 40 rotates to roll up and recover the fired treatment object 2. Further, referring to FIG. 3, the treatment object 2 can bend between the unwinding mechanism 20 and the roller group 50 and between the roller group 50 and the winding mechanism 40, and there are no other components that apply a tensile force to the treatment object 2 except for the unwinding mechanism 20, the winding mechanism 40, and the roller group 50.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A heat treatment system comprising:
an unwinding mechanism configured to unwind a ribbon-shaped treatment object;
a plurality of rollers configured to convey the treatment object by each roller rotating after the treatment object has been unwound by the unwinding mechanism; and
a firing furnace configured to fire the treatment object conveyed by the plurality of rollers,
wherein the plurality of rollers is constituted of a heat-resistant material that is usable in a temperature range of 600° C. to 1400° C. and conveys the treatment object while being in contact with the treatment object.

2. The heat treatment system according to claim 1, wherein portions of surfaces of the plurality of rollers that contact the treatment object are smoothed.

3. The heat treatment system according to claim 2, wherein a surface roughness of the portions of the surfaces is Ra 6.3 μm or less.

4. The heat treatment system according to claim 1, wherein the plurality of rollers is constituted of ceramics with an alumina content percentage of 50% to 70%.

5. The heat treatment system according to claim 1, further comprising a roller drive control unit configured to change a conveyance speed of one or more rollers of the plurality of rollers based on shrinkage of the treatment object caused by firing in the firing furnace.

6. The heat treatment system according to claim 5, wherein
the firing furnace comprises:
a heating zone in which a temperature inside the firing furnace is increased;
a maintaining zone in which the temperature inside the firing furnace increased in the heating zone is maintained; and
a cooling zone in which the temperature inside the firing furnace is decreased,
the heating zone, the maintaining zone, and the cooling zone are arranged in this order from an upstream end to a downstream end of conveyance by the plurality of rollers, and
the roller drive control unit slows down the conveyance speed of rollers located downstream of a predetermined position in the heating zone compared to rollers located upstream of the predetermined position.

7. The heat treatment system according to claim 1, further comprising a winding mechanism configured to wind up the treatment object fired by the firing furnace.

8. The heat treatment system according to claim 1, wherein the treatment object is a glass, ceramics, a metal, or a mixture thereof.
